(19) United States
(12) Patent Application Publication
(10) Pub. No.: US 2025/0318610 A1
(43) Pub. Date: Oct. 16, 2025

(54) HEAD MOUNTED DISPLAY DEVICE AND STRAP MODULE THEREOF

(71) Applicant: HTC Corporation, Taoyuan City (TW)

(72) Inventors: Ying-Chieh Huang, Taoyuan City (TW); Chun-Kai Yang, Taoyuan City (TW); Yen-Te Chiang, Taoyuan City (TW)

(73) Assignee: HTC Corporation, Taoyuan City (TW)

(21) Appl. No.: 18/964,704

(22) Filed: Dec. 2, 2024

Related U.S. Application Data
(60) Provisional application No. 63/633,856, filed on Apr. 15, 2024.

(51) Int. Cl. A44C 5/18

(52) U.S. Cl. CPC A44C 5/18

(57) ABSTRACT

Provided are a head mounted display device and a strap module thereof. The strap module includes a first strap and a second strap. The first strap has a first end, a second end, a first pivot portion, and a second pivot portion. The first end and the second end are respectively connected to opposite sides of a host. The first pivot portion and the second pivot portion are located between the first end and the second end. A length of a part of the first strap between the first pivot portion and the second pivot portion is elastically variable. The second strap has a third end and a fourth end. The second strap is rigid and has an adjustable length. The third end is pivotally connected to the first pivot portion. The fourth end is pivotally connected to the second pivot portion.

### CROSS-REFERENCE TO RELATED APPLICATION

This application claims the priority benefit of U.S. provisional application Ser. No. 63/633,856, filed on Apr. 15, 2024. The entirety of the above-mentioned patent application is hereby incorporated by reference herein and made a part of this specification.

### BACKGROUND

### Technical Field

This application relates to a display device and a band module thereof, and in particular to a head mounted display device and a strap module thereof.

### Description of Related Art

With the rapid advancement of current technology, the types and functions of head-mounted display devices are becoming more and more diversified. Taking a goggle-type head-mounted display device as an example, when a user wears this type of device, the gyroscope and position tracker inside the head-mounted display device track the movement status of the user to project the corresponding scene images, providing the user with an experience akin to being situated in a virtual world.

Most existing head-mounted display devices use either a rigid bracket or a soft strap to secure the device to the head of the user. Rigid brackets have the advantages of high stability, weight balance, and the ability to attach a battery module, but the disadvantages are that they are difficult to fit people with different head sizes, resulting in poorer comfort, and the part of the rigid bracket at the back of the head makes it difficult for users to lie down and use the device. Soft straps can provide a more comfortable user experience; however, they are less stable and difficult to add external batteries and adjust to the proper tension.

### SUMMARY

The application provides a head mounted display device and a strap module thereof, capable of improving an issue of difficulty in balancing device stability and comfort.

The head mounted display device of this application includes a host and a strap module. The strap module includes a first strap and a second strap. The first strap has a first end, a second end, a first pivot portion, and a second pivot portion. The first end and the second end are connected to the opposite sides of the host respectively. The first pivot portion and the second pivot portion are located between the first end and the second end. A length of a part of the first strap between the first pivot portion and the second end is elastically variable. The second strap has a third end and a fourth end. The second strap is rigid and has an adjustable length. The third end is pivotally connected to the first pivot portion. The fourth end is pivotally connected to the second pivot portion.

The strap module of this application includes a first strap and a second strap. The first strap has a first end, a second end, a first pivot portion, and a second pivot portion. The first end and the second end are respectively connected to the opposite sides of a host. The first pivot portion and the second pivot portion are located between the first end and the second end. a length of a part of the first strap between the first pivot portion and the second end is elastically variable. The second strap has a third end and a fourth end. The second strap is rigid and has an adjustable length. The third end is pivotally connected to the first pivot portion. The fourth end is pivotally connected to the second pivot portion.

Based on the above, in the head mounted display device and the strap module thereof of this application, the rotatable rigid strap provides a stable and comfortable wearing experience.

### BRIEF DESCRIPTION OF THE DRAWINGS

FIG. 1 is a schematic diagram of a head mounted display device according to an embodiment of the invention.

FIG. 2 is an action diagram of a second strap of a strap module of the head mounted display device in FIG. 1.

FIG. 3 is a schematic diagram of a part of the strap module of the head mounted display device in FIG. 1.

FIG. 4 is a schematic diagram of a coupling portion of the strap module of the head mounted display device in FIG. 1.

FIG. 5A is a schematic diagram of a first tether section and the tether string section of the strap module of the head mounted display device in FIG. 1.

FIG. 5B is a schematic diagram of some elements of the strap module of the head mounted display device in FIG. 5A.

FIG. 6 is a schematic diagram of the first tether section of the strap module in FIG. 5A.

FIG. 7 is a schematic diagram of the second tether section of the strap module in FIG. 5A.

FIG. 8 is a schematic diagram of a head mounted display device according to another embodiment of the invention.

FIG. 9 is a schematic diagram of another state of a strap module of the head mounted display device in FIG. 8.

FIG. 10 is a schematic diagram of a tether section of the strap module of the head mounted display device in FIG. 8.

### DESCRIPTION OF THE EMBODIMENTS

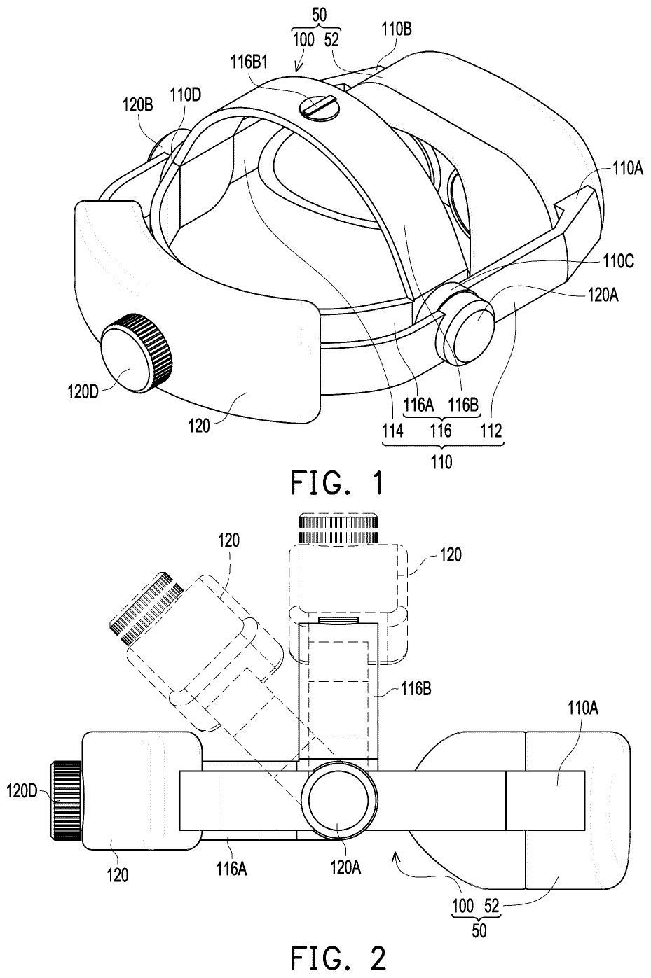

FIG. 1 is a schematic diagram of a head mounted display device according to an embodiment of the invention. Referring to FIG. 1, a head mounted display device 50 of this embodiment includes a host 52 and a strap module 100. The strap module 100 is used to fix the host 52 on the head of the user.

In this embodiment, the host 52 may be applied to fields such as a virtual reality system, an augmented reality system, or a mixed reality system. The host 52 may include components such as an optical system and a protective housing, and may be provided with a display or be suitable for placing a display. The display may be a built-in display or an external portable display (such as a smart phone), but the application is not limited thereto. The optical system includes optical elements used to change the light path of the display, such as lenses, light guides, or prisms. The host 52 in FIG. 1 is presented in a slightly larger form, but the host 52 can also be in a lighter form or other forms.

FIG. 2 is an action diagram of a second strap of a strap module of the head mounted display device in FIG. 1. Referring to FIG. 1 and FIG. 2, the strap module 100 of this embodiment includes a first strap 110 and a second strap 120. The first strap 110 has a first end 110A, a second end 110B, a first pivot portion 110C, and a second pivot portion 110D. The first end 110A and the second end 110B are connected to opposite sides of the host 52 respectively. The first pivot portion 110C and the second pivot portion 110D are located between the first end 110A and the second end 110B. The length of the part of the first strap 110 between the first pivot portion 110C and the second pivot portion 110D is elastically variable. That is, the part of the first strap 110 between the first pivot portion 110C and the second pivot portion 110D is made of elastic material, such as fabric or other materials, which can conform to the head of the user, providing not only support but also a comfortable wearing sensation.

The second strap 120 has a third end 120A and a fourth end 120B. The second strap 120 is rigid and the length is adjustable. That is, the distance between the third end 120A and the fourth end 120B can be changed to accommodate users with different head sizes. Moreover, the rigid second strap 120 has high stability, balanced weight, and can also be attached with a battery module. The third end 120A of the second strap 120 is pivotally connected to the first pivot portion 110C. The fourth end 120B of the second strap 120 is pivotally connected to the second pivot portion 110D. Therefore, the second strap 120 can be pivotally connected relative to the first strap 110, for example, to a horizontal position to contact the back of the head of the user, thereby providing the most stable support effect. Alternatively, the second strap 120 can be rotated to a vertical orientation to contact the top of the head of the user, so that the user does not feel uncomfortable with the second strap 120 stuck in the back of the head, whether the user is in a seated position and leaning back against a chair or lying down. In other words, since the part of the first strap 110 between the first pivot portion 110C and the second pivot portion 110D is made of elastic material, such as fabric or other materials, when the user leans back against a chair or lies down, the first strap 110 can conform to the head of the user, providing not only support but also a comfortable wearing sensation. Of course, the second strap 120 can be rotated in other orientations, which is not limited by this application. In addition, between the third end 120A and the first pivot portion 110C, as well as between the fourth end 120B and the second pivot portion 110D, appropriate segmented or continuous engagement forces can be provided, enabling the second strap 120 to remain in the position desired by the user, as illustrated in FIG. 2. In other words, the second strap 120 can be rotated by the user to any position on the top of the head or between the top of the head and the back of the head. FIG. 2 merely illustrates a 45-degree position for explanatory purposes.

In this embodiment, the first strap 110 includes a first sub-strap 112, a second sub-strap 114, and a third sub-strap 116. The first sub-strap 112 has a first end 110A and a first pivot portion 110C. The second sub-strap 114 has a second end 110B and a second pivot portion 110D. The first sub-strap 112 and the second sub-strap 114 are rigid. The third sub-strap 116 is connected to the first pivot portion 110C and the second pivot portion 110D, and the length of the third sub-strap 116 is elastically variable. For example, the third sub-strap 116 may be made of elastic material, such as fabric or other materials.

In this embodiment, the third sub-strap 116 includes a first straight bar 116A and a second straight bar 116B. The first straight bar 116A is connected to the first pivot portion 110C and the second pivot portion 110D and is used to contact the back the head of the user. The second straight bar 116B is connected to the first pivot portion 110C and the second pivot portion 110D and is used to contact the top of the head of the user. For example, two ends of the first straight bar 116A are respectively connected to two ends of the second straight bar 116B. An included angle between the first straight bar 116A and the second straight bar 116B is, for example, 90 degrees, but this application is not limited thereto. The first straight bar 116A extends from the right side of the head of the user through the back of the head to the left side, and the second straight bar 116B extends from the right side of the head of the user through the top of the head to the left side. Therefore, when the user leans back against a chair or lies down, the third sub-strap 116 can conform to the head of the user, providing not only support but also a comfortable wearing sensation.

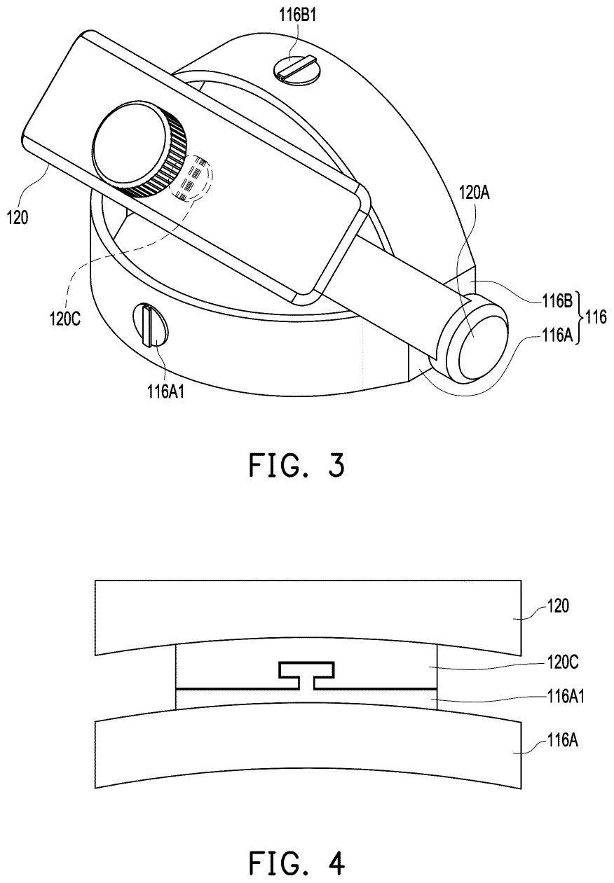

FIG. 3 is a schematic diagram of a part of the strap module of the head mounted display device in FIG. 1. FIG. 4 is a schematic diagram of a coupling portion of the strap module of the head mounted display device in FIG. 1. Referring to FIG. 3 and FIG. 4, in this embodiment, in order to allow the second strap 120 to be more stably fixed on the top of the head or the back of the head, the middle section of the second strap 120 may also have a first coupling portion 120C. The first straight bar 116A may also have a second coupling portion 116A1. The second straight bar 116B may also have a third coupling portion 116B1. When the second strap 120 is pivotally connected to the back of the head of the user, the first coupling portion 120C is used to couple with the second coupling portion 116A1. When the second strap 120 is pivotally connected to the top of the head of the user, the first coupling portion 120C is used to couple with the third coupling portion 116B1. In this manner, the second strap 120 can be fixed on the back of the head of the user or on the top of the head of the user. The first coupling portion 120C and the second coupling portion 116A1 of this embodiment are coupled to each other, for example, using a concave-convex matching design, but they may also be coupled to each other using hook-and-loop matching, Velcro, magnetic attachment, or other designs. Similarly, this embodiment may not have the first coupling portion 120C, the second coupling portion 116A1, and the third coupling portion 116B1, but only have the structure between the third end 120A and the first pivot portion 110C, and between the fourth end 120B and the second pivot portion 110D, to provide appropriate segmented or continuous engagement forces to keep the second strap 120 in the position desired by the user.

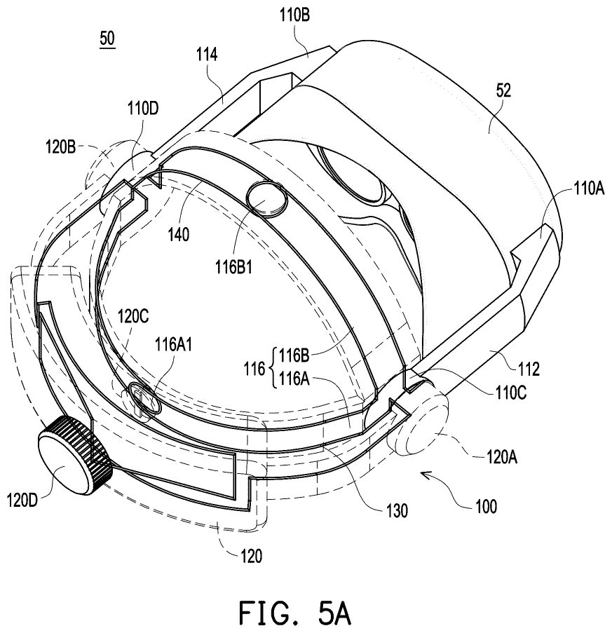

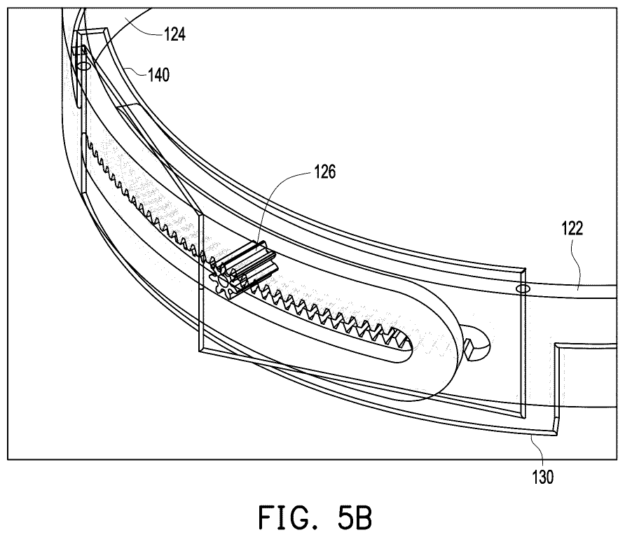

FIG. 5A is a schematic diagram of a first tether section and the tether string section of the strap module of the head mounted display device in FIG. 1. FIG. 5B is a schematic diagram of some elements of the strap module of the head mounted display device in FIG. 5A. Some elements in the figure are shown in a transparent state with dashed lines to facilitate comprehension of other internal elements. Referring to FIG. 5A and FIG. 5B, in this embodiment, the strap module 100 further includes a first tether section 130 and a second tether section 140. In this embodiment, the first tether section 130 and the second tether section 140 are the same tether, but for convenience in describing the distribution positions of the tethers, they are therefore distinguished as the first tether section 130 and the second tether section 140. The middle section of the second strap 120 has an adjustment member 120D. The point of separation between the first tether section 130 and the second tether section 140 is located at the adjustment member 120D. In other embodiments, the first tether section 130 and the second tether section 140 may also be independent strings, but one end of both is fixed at the adjustment member 120D.

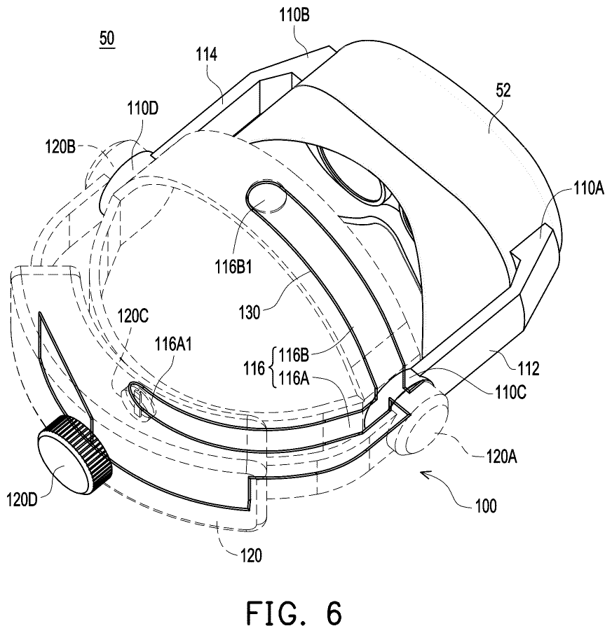

FIG. 6 is a schematic diagram of the first tether section of the strap module in FIG. 5A. Referring to FIG. 6 together, the distribution path of the first tether section 130 sequentially passes through the first sub-strap 112, the middle section of the second straight bar 116B, the first pivot portion 110C, the middle section of the first straight bar 116A, the first pivot portion 110C, and the adjustment member. 120D. The second strap 120 of this embodiment includes, for example, a first rack 122 and a second rack 124 that are partially overlapping, and the first rack 122 and the second rack 124 may be coupled to each other using gears 126. Between the first pivot portion 110C and the adjusting member 120D, the first tether section 130 is, for example, threaded from the first pivot portion 110C through the first rack 122, then through the second rack 124, and then into the adjusting member 120D and connected to the second tether section 140. Referring to FIG. 5B, for more details, the first tether section 130 passes through the interior of the first rack 122 and then passes out of the lower surface of the first rack 122, passes under the gear 126, passes through the second rack 124 from the lower surface of the second rack 124, passes above the second rack 124 and then into the adjusting member 120D and connects with the second tether section 140.

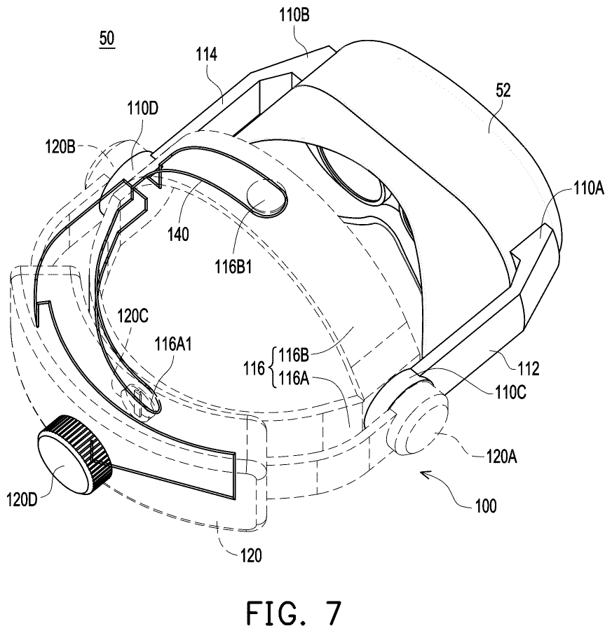

FIG. 7 is a schematic diagram of the second tether section of the strap module in FIG. 5A. Referring to FIG. 7 together, the distribution path of the second tether section 140 sequentially passes through the second sub-strap 114, the middle section of the second straight bar 116B, the second pivot portion 110D, the middle section of the first straight bar 116A, the second pivot portion 110D, and the adjustment member 120D. Between the second pivot portion 110D and the adjusting member 120D, the second tether section 140 is, for example, threaded from the second pivot portion 110D through the second rack 124, then through the first rack 122, and then into the adjusting member 120D and connected to the first tether section 130. Referring to FIG. 5B, for more details, the second tether section 140 passes through the interior of the second rack 124 and then passes out of the upper surface of the second rack 124, passes above the gear 126, passes through the first rack 122 from the upper surface of the first rack 122, passes under the first rack 122 and then into the adjusting member 120D and connects with the first tether section 130.

In this embodiment, the second coupling portion 116A1 is located in the middle section of the first straight bar 116A, so the first tether section 130 appears to bypass the second coupling portion 116A1, but in fact the first tether section 130 is not limited to bypassing the second coupling portion 116A1. The third coupling portion 116B1 is located in the middle section of the second straight bar 116B, so the second tether section 140 appears to bypass the third coupling portion 116B1, but in fact the second tether section 140 is not limited to bypassing the third coupling portion 116B1.

The adjusting member 120D is used to extend and retract the first tether section 130 and the second tether section 140 to change the lengths of the first straight bar 116A and the second straight bar 116B, and also change the overall length of the second strap 120 at the same time. Specifically, when the adjusting member 120D pulls the first tether section 130, due to the fact that the first tether section 130 passes through the first rack 122 and the second rack 124, it alters the overlapping length between the first rack 122 and the second rack 124, thereby modifying the overall length of the second strap 120. More specifically, since the first tether section 130 passes through the second rack 124, when the adjustment member 120D pulls the first tether section 130, the first tether section 130 pulls the second rack 124 to move towards the direction of the adjustment member 120D, thereby increasing the overlapping length between the first rack 122 and the second rack 124. Furthermore, the first tether section 130 bypasses the part between the middle portion of the first straight bar 116A and the first pivot portion 110C, and the first tether portion 130 bypasses the part between the middle portion of the second straight bar 116B and the first pivot portion 110C. Consequently, when the first tether section 130 is tightened, it results in a reduction of the length of the parts of the first straight bar 116A and the second straight bar 116B that are proximate to the first pivot portion 110C.

In addition, when the adjusting member 120D pulls the first tether section 130, it also pulls the second tether section 140 simultaneously. Since the second tether section 140 passes through the first rack 122 and the second rack 124, the overlapping length between the first rack 122 and the second rack 124 is also changed, that is, the overall length of the second strap 120 is changed. In more detail, since the second tether section 140 penetrates through the first rack 122, when the adjusting member 120D pulls the second tether section 140, the second tether section 140 pulls the first rack 122 to move toward the adjusting member 120D, that is, the overlapping length between the first rack 122 and the second rack 124 is increased. In addition, the second tether section 140 bypasses the part between the middle portion of the first straight bar 116A and the second pivot portion 110D, and the second tether portion 140 bypasses the part between the middle portion of the second straight bar 116B and the second pivot portion 110D. Consequently, when the second tether section 140 is tightened, it results in a reduction of the length of the parts of the first straight bar 116A and the second straight bar 116B that are proximate to the second pivot portion 110D.

Overall, when the adjusting member 120D pulls the first tether section 130 and the second tether section 140, the lengths of the entire first straight bar 116A and the second straight bar 116B may be shortened, and the length of the entire second strap 120 may also be shortened until the user feels that the first strap 110 stabilizes the host 52 at the head of the user. For example, the adjustment member 120D may be a knob. When the adjustment member 120D rotates, part of the first tether section 130 and the second tether section 140 can be wrapped around the adjustment member 120D to tighten the first strap 110, or allow the part of the first tether section 130 and the second tether section 140 wrapped around the adjusting member 120D to be released to loosen the first strap 110.

In other embodiments not shown, the adjusting member 120D can be connected to the gear 126, and rotating adjusting member 120D can drive the gear 126 to change the overlapping length between the first rack 122 and the second rack 124, that is, changing the overall length of the second strap 120. At this time, even if the first tether section 130 does not pass through the first rack 122 and the second rack 124 at the same time, and the second tether section 140 does not pass through the first rack 122 and the second rack 124 at the same time, the user can still adjust the length of the first strap 110 and the second strap 120 in a single action.

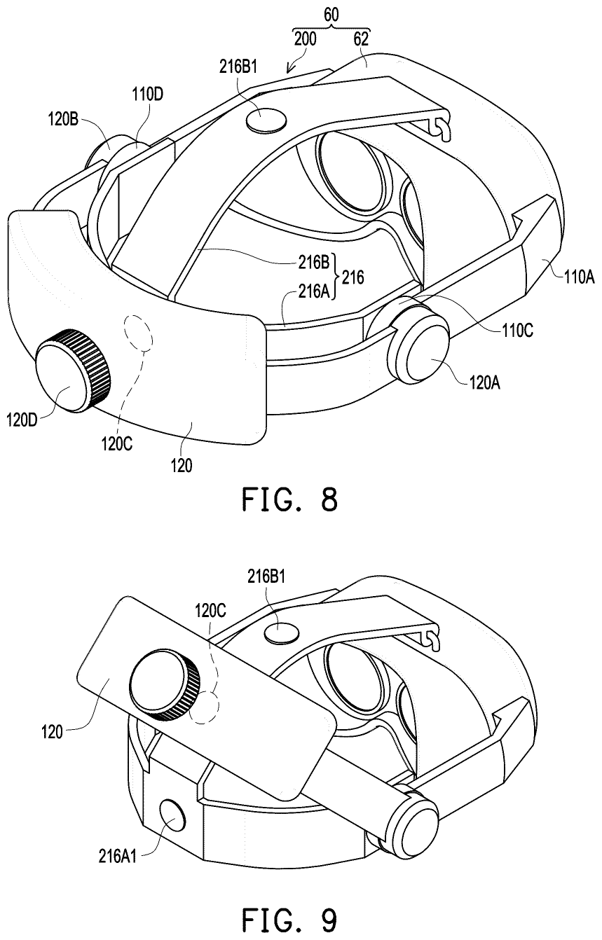

FIG. 8 is a schematic diagram of a head mounted display device according to another embodiment of the invention. FIG. 9 is a schematic diagram of another state of a strap module of the head mounted display device in FIG. 8. Referring to FIG. 8 and FIG. 9, a head mounted display device 60 of this embodiment is similar to the head mounted display device 50 of FIG. 1. Only the differences between the two are described in the following. A third sub-strap 216 of a strap module 200 of the head mounted display device 60 in this embodiment includes a first straight bar 216A and a second straight bar 216B. The first straight bar 216A is connected to the first pivot portion 110C and the second pivot portion 110D, and is used to contact the back of the head of the user. The second straight bar 216B is connected to the middle section of the first straight bar 216A and the host 52, and is used to contact the top of the head of the user. An included angle between the first straight bar 216A and the second straight bar 216B is, for example, 90 degrees, but this application is not limited thereto. The first straight bar 216A extends from the right side of the head of the user through the back of the head to the left side, and the second straight bar 216B extends from the back of the head of the user through the top of the head to the front.

In this embodiment, the first straight bar 216A has a second coupling portion 216A1. The second straight bar 216B has a third coupling portion 216B1. When the second strap 120 is pivotally connected to the back of the head of the user, the first coupling portion 120C is used to couple with the second coupling portion 216A1. When the second strap 120 is pivotally connected to the top of the head of the user, the first coupling portion 120C is used to couple with the third coupling portion 216B1. In this manner, the second strap 120 can be fixed on the back of the head of the user or on the top of the head of the user.

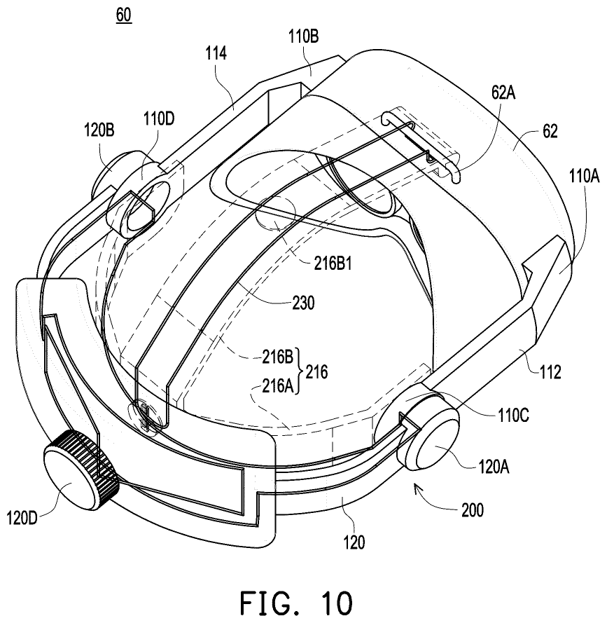

FIG. 10 is a schematic diagram of a tether section of the strap module of the head mounted display device in FIG. 8. Referring to FIG. 10, in this embodiment, the strap module 200 further includes a tether section 230. The distribution path of the tether section 230 sequentially passes through the adjustment member 120D, the first pivot portion 110C, the middle section of the first straight bar 216A, one end of the second straight bar 216B connected to the host 52, the middle section of the first straight bar 216A, the second pivot portion 110D, and the adjustment member 120D. For example, a host 62 of this embodiment has a cross bar 62A, the second straight bar 216B is connected to the cross bar 62A, and the tether section 230 also bypasses the cross bar 62A. The adjusting member 120D is used to extend and retract the tether section 230 to elastically change the lengths of the first straight bar 216A and the second straight bar 216B. Since the tether section 230 bypasses the entire first straight bar 216A and the second straight bar 216B, when the adjusting member 120D pulls the tether section 230, the lengths of the entire first straight bar 216A and the second straight bar 216B can be shortened until the user feels that the third sub-strap 110 stabilizes the host 52 at the head of the user. Similarly, the adjusting member 120D can also be used to adjust the length of the second strap 120, and the adjusting member 120D can simultaneously adjust the lengths of the third sub-strap 216 and the second strap 120. In addition, the detailed structure and operation method of the tether section 230 driving the second strap 120 are as described in the previous embodiments and therefore are not repeated again in the following.

To sum up, in the head mounted display device and the strap module thereof of the application, the rigid strap can provide stable support on the back of the head, and the rigid strap can also be rotated away from the back of the head to avoid uncomfortable leaning back of the head of the user, and the elastic strap can conform to the head of the user, providing a stable and comfortable wearing experience under different operating requirements, such as standing, sitting, lying down, and other operating modes in different usage situations. In addition, when using the adjustment member and tether, the user only needs to rotate the adjustment member to synchronize the tensioning of the rigid strap and elastic strap by the tether.

What is claimed is:

1. A head mounted display device, comprising:
a host;
a strap module, comprising:
a first strap, having a first end, a second end, a first pivot portion, and a second pivot portion, wherein the first end and the second end are connected to opposite sides of the host respectively, the first pivot portion and the second pivot portion are located between the first end and the second end, and a length of a part of the first strap between the first pivot portion and the second end is elastically variable; and
a second strap, having a third end and a fourth end, wherein the second strap is rigid and has an adjustable length, the third end is pivotally connected to the first pivot portion, and the fourth end is pivotally connected to the second pivot portion.

2. The head mounted display device according to claim 1, wherein the first strap comprises a first sub-strap, a second sub-strap, and a third sub-strap, the first sub-strap has the first end and the first pivot portion, the second sub-strap has the second end and the second pivot portion, the first sub-strap and the second sub-strap are rigid, the third sub-strap is connected to the first pivot portion and the second pivot portion, and a length of the third sub-strap is elastically variable.

3. The head mounted display device according to claim 2, wherein the third sub-strap comprises a first straight bar and a second straight bar, the first straight bar is connected to the first pivot portion and the second pivot portion and is configured to contact a back of a head of a user, and the second straight bar is connected to the first pivot portion and the second pivot portion and is configured to contact a top of the head of the user.

4. The head mounted display device according to claim 3, wherein a middle section of the second strap has a first coupling portion, the first straight bar has a second coupling portion, the second straight bar has a third coupling portion, when the second strap pivots to the back of the head of the user, the first coupling portion is configured to couple to the second coupling portion, and when the second strap pivots to the top of the head of the user, the first coupling portion is configured to couple to the third coupling portion.

5. The head mounted display device according to claim 3, wherein the strap module further comprises a first tether section and a second tether section, a middle section of the second strap has an adjustment member, a distribution path of the first tether section sequentially passes through the first sub-strap, a middle section of the second straight bar, the first pivot portion, a middle section of the first straight bar, the first pivot portion, and the adjustment member, a distribution path of the second tether section sequentially passes through the second sub-strap, the middle section of the second straight bar, the second pivot portion, the middle section of the first straight bar, the second pivot portion, and the adjustment member, the adjustment member is configured to extend and retract the first tether section and the second tether section to elastically change lengths of the first straight bar and the second straight bar, and the adjustment member is configured to adjust the length of the second strap.

6. The head mounted display device according to claim 2, wherein the third sub-strap comprises a first straight bar and a second straight bar, the first straight bar is connected to the first pivot portion and the second pivot portion and is configured to contact a back of a head of a user, and the second straight bar is connected to a middle section of the first straight bar and is configured to contact a top of the head of the user.

7. The head mounted display device according to claim 6, wherein a middle section of the second strap has a first coupling portion, the first straight bar has a second coupling portion, the second straight bar has a third coupling portion, when the second strap pivots to the back of the head of the user, the first coupling portion is configured to couple to the second coupling portion, and when the second strap pivots to the top of the head of the user, the first coupling portion is configured to couple to the third coupling portion.

8. The head mounted display device according to claim 6, wherein the strap module further comprises a tether section, a middle section of the second strap has an adjustment member, a distribution path of the tether section sequentially passes through the adjustment member, the first pivot portion, the middle section of the first straight bar, one end of the second straight bar connected to the host, the middle section of the first straight bar, the second pivot portion, and the adjustment member, the adjustment member is configured to extend and retract the tether section to elastically change lengths of the first straight bar and the second straight bar, and the adjustment member is configured to adjust the length of the second strap.

9. A strap module, comprising:
a first strap, having a first end, a second end, a first pivot portion, and a second pivot portion, wherein the first end and the second end are connected to opposite sides of a host respectively, the first pivot portion and the second pivot portion are located between the first end and the second end, and a length of a part of the first strap between the first pivot portion and the second end is elastically variable; and
a second strap, having a third end and a fourth end, wherein the second strap is rigid and has an adjustable length, the third end is pivotally connected to the first pivot portion, and the fourth end is pivotally connected to the second pivot portion.

10. The strap module according to claim 9, wherein the first strap comprises a first sub-strap, a second sub-strap, and a third sub-strap, the first sub-strap has the first end and the first pivot portion, the second sub-strap has the second end and the second pivot portion, the first sub-strap and the second sub-strap are rigid, the third sub-strap is connected to the first pivot portion and the second pivot portion, and a length of the third sub-strap is elastically variable.

11. The strap module according to claim 10, wherein the third sub-strap comprises a first straight bar and a second straight bar, the first straight bar is connected to the first pivot portion and the second pivot portion and is configured to contact a back of a head of a user, and the second straight bar is connected to the first pivot portion and the second pivot portion and is configured to contact a top of the head of the user.

12. The strap module according to claim 11, wherein a middle section of the second strap has a first coupling portion, the first straight bar has a second coupling portion, the second straight bar has a third coupling portion, when the second strap pivots to the back of the head of the user, the first coupling portion is configured to couple to the second coupling portion, and when the second strap pivots to the top of the head of the user, the first coupling portion is configured to couple to the third coupling portion.

13. The strap module according to claim 11 further comprising a first tether section and a second tether section, wherein a middle section of the second strap has an adjustment member, a distribution path of the first tether section sequentially passes through the first sub-strap, a middle section of the second straight bar, the first pivot portion, a middle section of the first straight bar, the first pivot portion, and the adjustment member, a distribution path of the second tether section sequentially passes through the second sub-strap, the middle section of the second straight bar, the second pivot portion, the middle section of the first straight bar, the second pivot portion, and the adjustment member, the adjustment member is configured to extend and retract the first tether section and the second tether section to elastically change lengths of the first straight bar and the second straight bar, and the adjustment member is configured to adjust the length of the second strap.

14. The strap module according to claim 10, wherein the third sub-strap comprises a first straight bar and a second straight bar, the first straight bar is connected to the first pivot portion and the second pivot portion and is configured to contact a back of a head of a user, and the second straight bar is connected to a middle section of the first straight bar and is configured to contact a top of the head of the user.

15. The strap module according to claim 14, wherein a middle section of the second strap has a first coupling portion, the first straight bar has a second coupling portion, the second straight bar has a third coupling portion, when the second strap pivots to the back of the head of the user, the first coupling portion is configured to couple to the second coupling portion, and when the second strap pivots to the top of the head of the user, the first coupling portion is configured to couple to the third coupling portion.

16. The strap module according to claim 14, further comprising a tether, wherein a middle section of the second strap has an adjustment member, a distribution path of the tether sequentially passes through the adjustment member, the first pivot portion, the middle section of the first straight bar, one end of the second straight bar connected to the host, the middle section of the first straight bar, the second pivot portion, and the adjustment member, the adjustment member is configured to extend and retract the tether to elastically change lengths of the first straight bar and the second straight bar, and the adjustment member is configured to adjust the length of the second strap.
